(19) United States
(12) Patent Application Publication
(10) Pub. No.: US 2013/0077937 A1
(43) Pub. Date: Mar. 28, 2013

(54) APPARATUS AND METHOD FOR PRODUCING REMOTE STREAMING AUDIOVISUAL MONTAGES

(71) Applicants: Sean Kennedy, San Diego, CA (US); Adrian Crisan, San Diego, CA (US); Gary Lyons, San Diego, CA (US)

(72) Inventors: Sean Kennedy, San Diego, CA (US); Adrian Crisan, San Diego, CA (US); Gary Lyons, San Diego, CA (US)

(73) Assignee: SONY CORPORATION, Tokyo (JP)

(21) Appl. No.: 13/245,462

(22) Filed: Sep. 26, 2011

(51) Int. Cl. H04N 5/91

(52) U.S. Cl. 386/241; 386/E05.003

(57) ABSTRACT

An apparatus and method for creating and performing an audio-visual montage assembled from tagged audio files matched with tagged video or graphic or photo image files in a hand held computation device and preferably performed on an external display device such as a television or computer monitor that may also have associated audio performance systems.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention pertains generally to devices and methods for audio visual media performances and more particularly to a method for programmatic streaming of audio and user associated visual content from one device to another to provide the user with additional entertainment value.

2. Description of Related Art

The availability of comparatively inexpensive solid state memory has fueled the development of a variety of small scale audio and video recording and performance devices. These devices can be populated with audio or video media files downloaded from the Internet or a computer and have essentially eliminated the need for physical recorded media such as magnetic media or a CD-ROM to provide an audio or video performance.

Recent advances in consumer electronic devices have also produced many different hand-held computing and Internet access products and supporting infrastructure. Laptop computers, cellular telephones, tablets and other portable devices have become commonplace. The computing capability of these types of handheld devices continues to increase.

In addition to becoming smaller, an increasing number of consumer electronic devices are network enabled and capable of accessing Web services through the Internet operated by the device vendor or by third parties, home wireless routers and public or commercial WiFi hotspots. With their ability to access the Internet directly, these consumer electronic devices no longer rely on the traditional personal computer wired to a telephone system as intermediary device.

Standardization of communications systems over time has provided interoperability between different types of devices so that device-to-device communications and device to Internet communications are routine. High definition televisions, computer monitors and hand-held device displays permit the performance of audio and video works in both indoor and outdoor settings.

One drawback to the miniaturization of audio and audiovisual devices is the limitation in size of audio speakers that can be accommodated by the device. Undersized speakers can diminish the fidelity of the performance losing the full range of sounds. Small speakers also reduce the distance between the device and the users that is necessary for the users to hear the performance. Typically ear buds or earphones are used with hand held devices to improve the performance, essentially making them a single user device. Although the audio devices are capable of storing and performing digitized music, the music cannot be fully appreciated with small speakers.

Another drawback to current hand-held audiovisual devices such as cell phones or tablets is that the video capabilities of the device are not utilized with the performance of an audio file.

Accordingly a need exists for a system and method for creating an audio-video montage from associated audio and image files on a hand held device for viewing on a remote display such as a television. These needs and others are met within the present invention, which overcomes the deficiencies of previously developed devices and methods and is an improvement in the art.

### BRIEF SUMMARY OF THE INVENTION

The invention provides an apparatus and method for an audio-visual montage created from audio files matched with graphic/photo image files in a hand held device and preferably performed on an external device such as a television or computer monitor that may also have associated audio performance systems. The compilation of audio and graphics, photo or video files that is produced can range from a general association of media files by a single characteristic to a specific user defined association of images and audio file.

By way of example, and not of limitation, a preferred method for producing an audio-visual montage generally comprises the steps of tagging, compiling and performing. In one embodiment of the invention, audio files are tagged with an audio data tag that preferably includes the artist name, play length and at least one descriptor such as “pop-rock” or “classical” or other music genre. Other descriptors may include an image association indicator such as “ocean scene,” “forest scene,” “urban scene,” “people,” “musicians” or “random.”

Image or video files are also tagged with an image tag with at least one image descriptor of the subject matter of the image that correspond to the association indicators used with the audio tags such as “ocean scene,” “forest scene,” “wildlife,” “urban scene,” “motorcycles,” “people,” “musicians,” “rock concert” or “random,” etc. The image descriptor tag can also include the “artist name” so that the audio file and an artist image can be specifically paired if desired by the user. Image files can be graphic images, video or photographs taken by the user or publically available.

The audio and image file tagging is preferably done with a tagging interface on the hand held device that allows the user to assign audio or image tags to the individual media files. In one embodiment, the tagged audio files are saved in an optional library of tagged audio files and the image files are saved in an optional library of tagged image files. However, tagged media files do not need to be stored in any specific place within the memory structure of the hand held device.

Tagged audio files may be selected and grouped by artist or genre such as “jazz” or “hip hop” etc. The sorted group of files forms a playlist that is normally randomly ordered. The individual tagged audio files are then matched with tagged image or video files that correspond to the descriptors of the selected audio file. If the audio file is only tagged with a “random” tag, any image file, tagged or not, could be associated with the audio file.

Each audio file has a length of play time that can be divided into any number of increments to give the number of images to be displayed during the performance of the audio file. For example, an audio file that has a performance that is sixty seconds long would require six images if each image is displayed for ten seconds. If the image is displayed for twenty seconds then only three images would be required.

In addition, a background can also be displayed that is visible between the presentation of each of the images. This background can also be changed at different times during the performance or between audio files.

The associated audio and image files are compiled into a list that can be sequentially performed or randomly performed. The montage that is created by the compilation process in the hand held device and performed on another device is normally not stored in memory or otherwise recorded. However, in one embodiment the compiled playlist of audio files and associated image files may be stored to allow a repeat performance.

In another embodiment, the audio files are randomly selected and the images are associated and then performed in real time and no list is compiled. The process starts over with the next audio file. Accordingly, a performance of music and images may be different with each performance of the same playlist because the images and audio files may be randomly selected and associated.

In the preferred embodiment, the programming of the hand held device is used to wirelessly stream the montage to an external device such as a television or computer monitor. However, it will be understood that a wired connection could also be used. A wide variety of external devices may be available for use, but a HD television with a home theater audio system is particularly preferred. The digital audio files can be amplified and further processed with a home theater audio system to further enhance the audio performance and the images and video can be displayed on a large screen television or monitor in high definition, for example.

In use, the media stored on the handheld device or stored in a “cloud” location of a user has been tagged. The simplest audio tag and image tag is the name of a musical artist. In some settings, the name of the artist may already be present in the media file metadata and a separate tag with the name is not necessary. The user selects a media genre or artist on an interface on the handheld device. In one embodiment, programming searches media files that the user has access to (video, photo, and audio found locally or remotely) which have the selected “genre” or “artist” data tag. The programming of the device then compiles a list of audio files and image files that have been identified searching for performers and artists that have been grouped by data tag. A queue of audio tracks and corresponding tagged image files is then created. The program uses the handheld device to wirelessly stream the content to an external device as a compilation or montage of music, video, and photos that pertain to the artist.

If “genre” is selected, audio files of artists within the genre will be automatically selected for performance. Images and videos with matching tags will be automatically sorted and associated with the audio files. The artists and images will be sorted and placed in the queue randomly. In this embodiment, the streaming video montage can be compiled on the fly providing a unique listening and viewing experience each time.

Embodiments of the present invention can provide a number of beneficial aspects which can be implemented either separately or in any desired combination without departing from the present teachings.

According to one aspect of the invention, a method for producing an audio-visual montage presentation from a portable device for viewing on an external performance device is provided that associates audio files with relevant image or video files to enhance the entertainment value of the audio content.

Another aspect of the invention is to provide an audio-visual performance from a remote hand held device that is performed on a second audio-visual device utilizing a data stream communicated by a cable, wirelessly, or over a Power Line Communication (PLC) system.

Another aspect of the invention is to provide a system and method for sorting and selecting audio files and associating image and video files on a hand held device by artist, subject matter or user defined criteria.

A further aspect of the invention is to provide a system that automatically compiles an audio-visual montage from tagged audio files and corresponding tagged video files that can produce a different visual performance each time the audio file is selected.

Another aspect of the invention is to provide a system and method that can form an audio-video montage on-the-fly compiled from prioritized tagged audio and video files present in a library of tagged audio and video files or simply present in a hand held device.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWINGS

The invention will be more fully understood by reference to the following drawings which are for illustrative purposes only:

FIG. 1 is a schematic diagram of an apparatus and system for producing and performing an audio-visual montage according to one embodiment of the invention.

FIG. 2 is an illustrative embodiment of an audio tagging interface on a display of a handheld device according to the invention.

FIG. 3 is an illustrative embodiment of an image tagging interface on a display of a handheld device according to the invention.

FIG. 4 is an illustrative embodiment of a performance interface on a display of a handheld device according to the invention.

FIG. 5 is a functional flow diagram of one embodiment of the method for producing and displaying an audio-video montage from a hand held device.

### DETAILED DESCRIPTION OF THE INVENTION

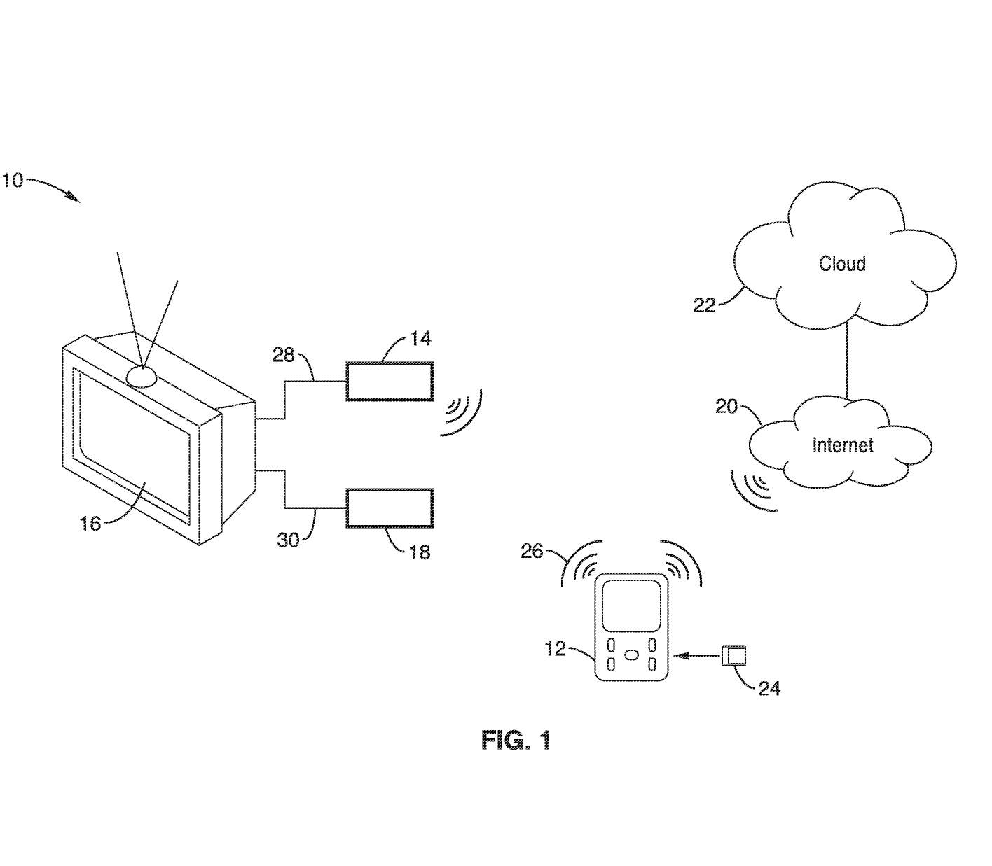

Referring more specifically to the drawings, for illustrative purposes the present invention is embodied in the apparatus and method generally shown in FIG. 1 through FIG. 5. It will be appreciated that the apparatus may vary as to configuration and as to details of the parts, and that the methods may vary as to the specific steps and sequence, without departing from the basic concepts as disclosed herein.

The present invention provides mechanisms for producing and displaying an audio-visual montage on a handheld device and performing it on a separate display. The audio file performance is accompanied by images or video associated with the audio file. The performance compilation is preferably wirelessly streamed to a performance display device or system in real time and each compilation is typically transitory and not saved as an independent.

Turning now to FIG. 1, one preferred embodiment of a system and method 10 for creating and performing an audio-visual montage created from audio files matched with graphic/photo image files in a hand held device 12 is schematically shown. The hand held device 12, is a network device that is preferably configured to wirelessly connect to a receiver 14 such as a wireless router. Alternatively, the handheld device 12 could wirelessly connect with a television with an integrated wireless receiver, or an amplifier or multimedia system with a wireless receiver.

Communications between the hand held device 12 and the receiver 14 can be by the use of conventional protocols such as the IEEE high-speed wireless communication protocols including 802.11b/g/n or Wireless Application Protocol (WAP) and many other protocols that permit communications between devices or with a wireless local area network (WLAN) in addition to Bluetooth, LTE, or any other wireless communication protocol supported by the devices.

Although wireless communications 26 are preferred, in one embodiment, the handheld device is configured to be wired directly to a performance device 16 without the need for a separate receiver 14 by a cable such as an HDMI, firewire, USB, LAN cables (100BASE-TX Ethernet cables, 1000BASE-T Ethernet cables), fiber optic cables, and any other hard wire connections that the devices support. In another embodiment, communications from the hand held device 12 to the receiver 14 or display 16 is through a power line communications (PLC) network.

The hand held device 12 can be any device that is capable of receiving and storing audio files and image/video files within a memory, executing software commands and transmitting wirelessly or by cable to a display 16.

There are many available multimedia devices which support the transmission, reception, and playback of the content that will be suitable. For example, the hand held device 12 could be WiFi enabled tablet, Internet access enabled personal digital assistant (PDA) or mobile telephone. It could also be a laptop or notebook computer, Netbook, Tablet PC, Tablet Television, or an All-in-one Portable Multimedia Playback device or similar device. These types of devices have interoperable communication, storage, and computing capabilities. The hand held device 12 preferably has an interface such as a keypad, stylus or soft buttons that allow the user to interact with the apparatus and software to control the creation and performance of the audio-video montage on a display device.

Storage of the audio files and image files utilized by the programming of the hand held device 12 can be part of the device 12 or can be removable media 24 such as a flash drive or other form of transferrable storage media. Loading and tagging of audio and image files can optionally take place with another device such as a PC table top computer and transferred to the hand held device 12 through the optional transferable media 24 in this embodiment.

The hand held device 12 can optionally have the capability of accessing the Internet 20 or be part of a “cloud computing” network 22 to provide a source of audio and image files or remote storage to the hand held device 12. The Internet may also be a route for communications between the hand held device 12 and the network receiver 14 or the “cloud” resources 22 of the user.

The performance can take place on a display 16 such as a high definition television or a personal computer that is normally configured with speakers. The display 16 can be connected directly to the receiver 14 by a wire 28 as shown in FIG. 1 or by a wireless signal produced by the receiver 14. In another embodiment, the receiver 14 is also connected 30 to a digital amplifier 18 such as a home theater system or digital audio system that preferably includes large speakers for an enhanced audio performance. The receiver 14, display 16, audio system 18 and Internet communications are shown separately for clarity in FIG. 1, it will be understood that these functions can be integrated or combined into one or two devices.

Referring specifically to the embodiment shown in FIG. 1, a typical system is generally shown for use in the home of the user. A wireless router is used as a receiver 14 and is connected to the television 16 and a home theater system 18. Music, for example, can be amplified as well as volume and quality controlled by the audio components of a home theater system 18.

The compilation of audio files and the graphics, photo or video files that is produced can range from a general association of media files by a single characteristic to a specific user defined set of associations of images with each audio file. The transmitted audio-visual montage performance is preferably created in real time by the hand held device 12 and then sent to the display 16 without forming and storing a separate file of the compilation of audio files and image files.

The association of audio files and image files is preferably accomplished by tagging the files with association tags that are ultimately made part of the metadata or file and saved on the hand held device 12 as a tagged media file. The music audio files are preferably tagged with at least a genre tag in addition to the artist name indicator if an indicator is necessary. A genre tag is a descriptor of a music type such as “Jazz,” “Country,” “Classical,” or “Folk” etc. In one embodiment, the genre tag can be a collection name tag that identifies the track as part of a user defined collection.

Another audio tag that may be applied to an audio file is a generic image descriptor tag. General images such as “landscapes,” “wildlife” “people” or “cars” and the like can be associated with the audio file. For example, a musical file could have a meditation tag and an image tag that is for an ocean scene. In another embodiment, a specific image tag is associated and applied to an audio file. For example, images of a particular artist, images of a musical performance, dance scenes, or a user defined category can be applied. In this case, images of a particular artist will be associated with the audio file of that artist or images categorized by the user.

Audio files could also be tagged by the mood they create. (i.e., Somber, Happy, Loved, Moody, Inspired, Upbeat, Sad, Nostalgic, etc.) Audio files could also be tagged by the Rhythm style. (i.e., fast, medium, slow, dance, ballad, etc).

Many audio, picture, and video files that are currently on the web have some form of identifier. This metadata can be gathered when the content is downloaded and can be automatically added to the library of tags belonging to each specific piece of media. i.e., a video of Michael Jackson on his “Dangerous” Tour might already have tags such as “Rock”, “Pop”, “R&B”, Michael Jackson”, “Dangerous”, “Flamino Stadium”, “Rome”, “Italy” and “1992”. This metadata can be intelligently filtered by genre, artist, date, location, etc. In the simplest form of the invention the streamed montage could use only tags that exist when the media is downloaded from the cloud. The association between picture and audio being the common tag types. (artist and genre).

The audio or image file can then be further tagged and customized by the invention and the user since the user may feel the existing tags are not enough or do not match his or her needs and likes. For example the User might want the streaming content to be filterable by whether or not the music/video comes from a live show or studio recording.

Image or video files can also be tagged with one or more association tags. Images can be photographic images, graphic art images or video files. Image association tags are usually a general descriptor of the subject matter of the image file.

Preferably, the image descriptor of the subject matter of the image corresponds to the association indicators used with the audio tags such as “ocean scene,” “forest scene,” “wildlife,” “urban scene,” “motorcycles,” “people,” “musicians,” “rock concert” or “random,” etc. The image descriptor can also include the “artist name” so that the audio file and an artist image can be specifically paired if desired by the user.

Another example would be that the user might want to add additional tags to filter music by mood, color, rhythm, etc. A rendition of “We are the World” might have extra tags added for green, blue, ocean scene, sky scene, wildlife.

Video and Image files could also be tagged by the mood they create. Such tags would include Somber, Happy, Romantic, Loved, Moody, Inspired, Upbeat, Sad, Nostalgic, etc.

Tagged audio files and image files can be stored on the hand held device 12 or on transportable media 24 such as a flash drive connected to the device 12. The tagged audio and image files can also be transferred from device to device. In one embodiment, pre-tagged audio files are made available for purchase by authorized and licensed distributors. Images with tags corresponding to the tags of the downloaded audio file can be optionally accessed over an Internet connection and saved on a computer, media or a hand-held device 12. Pre-tagged images and audio files can be controlled by the artist and further the popularity of the artist, for example. The downloadable pre-tagged images could also be a vehicle for advertisements and promotion.

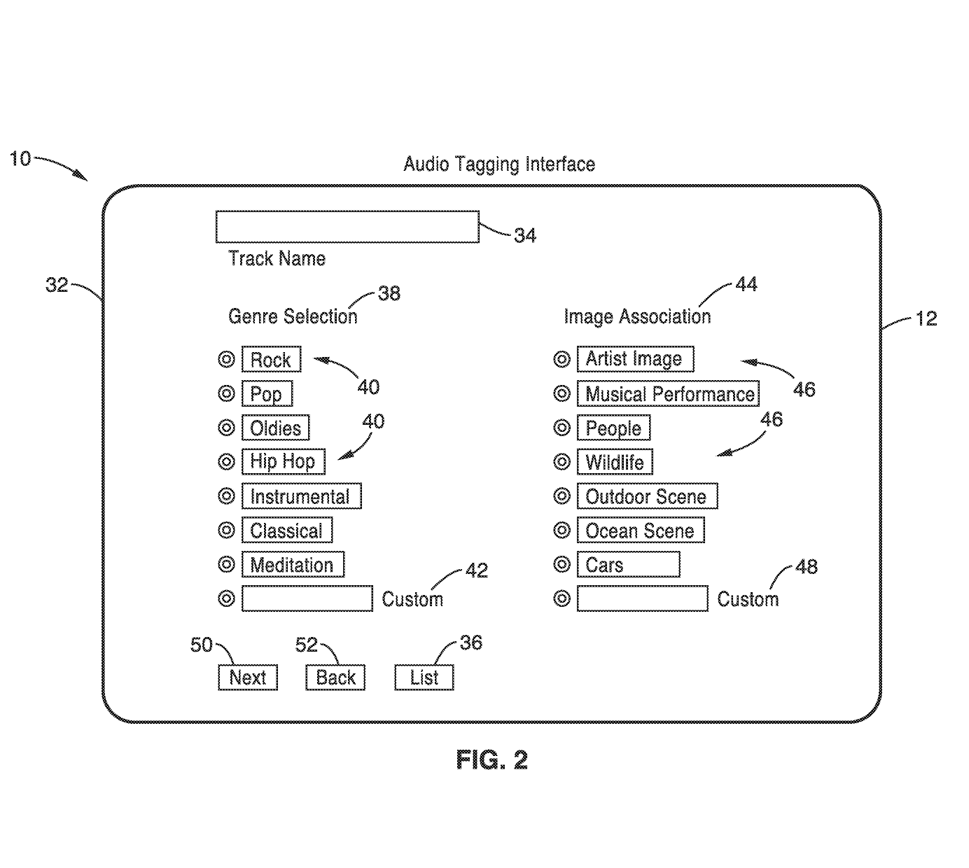

The audio files and the image files are preferably tagged and stored on the hand held device 12 with the use of three general interfaces: audio tagging; image tagging and performance. Referring now to FIG. 2, one embodiment of audio tagging interface 32 on handheld device 12 is schematically shown. When the audio tagging interface 32 is accessed, the audio files on the hand held device 12 and auxiliary storage on media 24 are sorted to form a list. The file or track name automatically appears in window 34. The audio interface 32 also has a list button 36 that will list the audio files by name and indicate whether the file has been tagged. The user can highlight the selected file from the list and that file will appear in window 34 for tagging or for changing the tags on the file.

The audio file that appears in window 34 can be tagged with two types of audio tags in this embodiment. The first audio tag that is selected is a “GENRE” tag 38. The user selects a general music type such as “Rock” and presses the corresponding button 40. The user can also select a “custom” button 42 that will give a custom user defined tag. When the custom button 42 is pressed by the user, a collection name can be entered by the user and the file will be tagged with the collection name. In one embodiment, more than one Genre tag can be applied to a music file so that a file can be tagged with a music genre such as “instrumental” and also be tagged as part of a collection.

An image association 44 can be selected by the user for the individual audio file. An image type that the user finds relevant can be selected by pressing one or more of the buttons 46. For example, the “ocean scenes” button 46 can be pressed with an audio file that has also been tagged with the “meditation” music type so that only ocean scenes will be part of the montage that is created and performed with this audio file.

A “custom” image association button 48 can be pressed allowing a keyboard entry of a custom image tag name. The custom tag allows the user to associate specifically selected image or video files that are to be associated with this audio file. For example, if the audio file was a speech at a political rally, tagged images of the rally could be associated with the audio file. Accordingly, any combination of generalized audio tags can be used along with the user option of creating a completely new “custom tag” is provided in this embodiment.

Once the tags are selected, the user can press the “NEXT” button 50 to advance to the next audio file in the list. Likewise, the user can press the “BACK” button 52 to go the to the previous audio file selection on the list. The tagged file is automatically saved at the original location of the file on the memory of the hand held device 12. In another embodiment, the tagged audio files are automatically saved in a library of tagged files established on the device 12 or the auxiliary storage media 24. Only those audio files that have not been tagged will be sorted and listed for tagging by the audio interface 32 and appear in window 34.

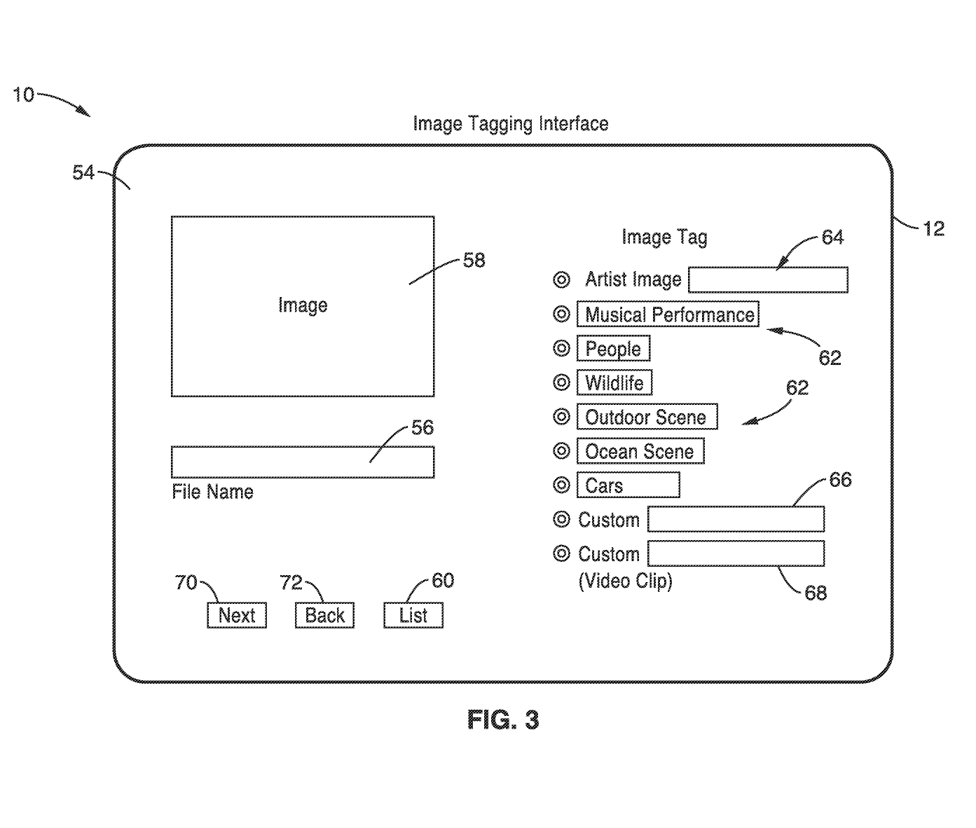

Turning now to FIG. 3, one embodiment of the image tagging interface 54 is schematically shown. When the image tagging interface 54 is accessed, the image files that are present on the hand held device 12 or on the associated media 24 on the device are sorted and listed. The name of the first image file on the list appears in window 56 and the image appears in box 58 for easy identification in this embodiment.

In another embodiment, the list of the image files that is developed can be accessed with the list button 60. The list of image files will preferably indicate whether the file has been tagged. The user can select an image from the list and the file name will appear in window 56 and the image will appear in box 58. Tags for the image can then be added or changed. In another embodiment, the list accessed by button 60 may include only those image files that have not been tagged.

One or more image tags can be applied to the image file by pressing one of the image tagging buttons 62 that correspond to common image types or groups that may be associated with an audio file. For example, images of “people”, “musical performances,” “wildlife,” or other general image types can be selected. The list of buttons 62 is illustrative of the image types and not intended to be limited to the general group tags that can be applied.

Specific image tags can also be applied to the image file that is selected in window 56. For example, the image can be identified by the name of the artist depicted by pressing button 64 and entering the name of the artist by a keyboard or other entry method. Similarly, custom tags can be applied by pressing button 66 on the image tagging interface 54 and entering a “custom image tag” name with a keyboard. These custom image tags may be used as a single tag or can be used in addition to one or more general image tags.

If a video clip is selected for tagging rather than a photograph or fine art or other graphic image, custom button 68 is pressed and a custom video tag is applied and named by entries with the keyboard. Normally, only the video portion of the video file is presented with the associated audio file and the video audio portion and the audio file are not mixed.

The tagged image file is automatically saved when the user closes the interface or presses the “NEXT” button 70 to tag the next image in line from the list of sorted images. The user can also access the preceding image file by pressing the “BACK” button 72. Tagged files can also be stored in a separate optional library of tagged image files in one embodiment of the invention.

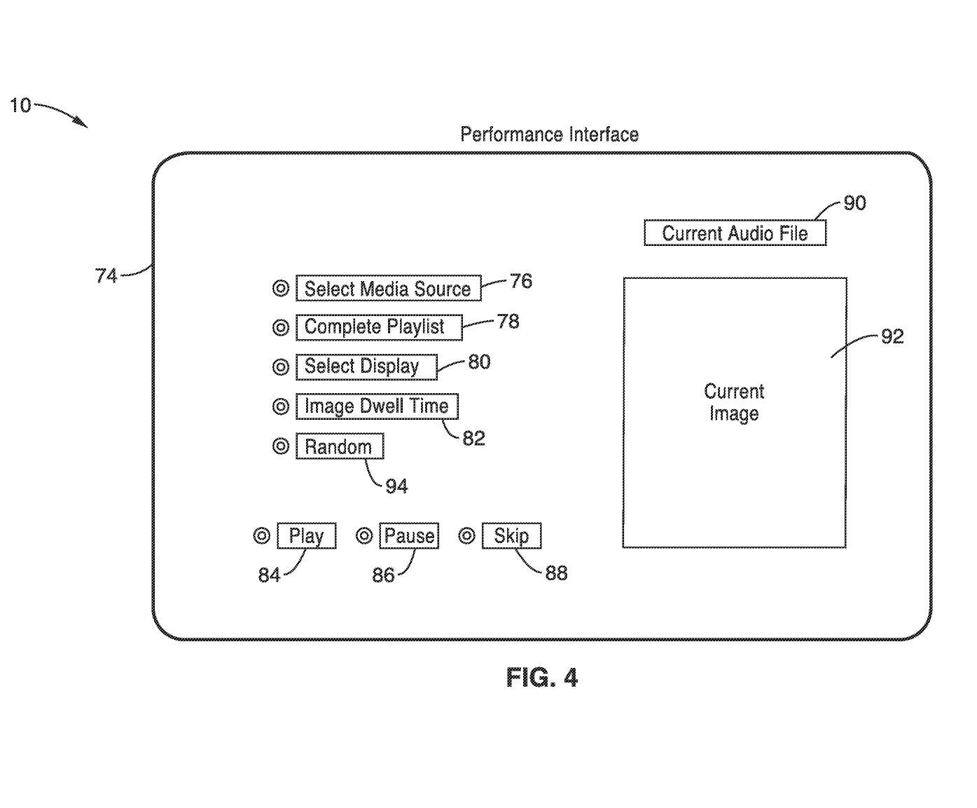

One embodiment of a performance interface 74 is shown in FIG. 4. The performance interface 74 allows the user to compile a playlist, select a display and initiate and control the performance of the audio-visual montage. The user can press the “SELECT MEDIA SOURCE” button 76 that will display and permit the selection of tagged audio and tagged image files from a variety of locations. For example, files on the media 24 can be selected. Tagged files could be accessed wirelessly over a local network or cloud resources or directly wired to another computer or storage device. The user could also select audio and image media files from optional libraries created on the hand held device 12. Typically the tagged audio and image files are stored on the hand held device 12 and the drive location of those files is selected.

The “COMPILE PLAYLIST” button 78 permits the selection of audio files by genre type or artist or by custom file tag and automatically creates a playlist from the files from the selected media source. For example, if an “instrumental” genre is selected, a playlist of audio files with the “instrumental” tag is automatically compiled and displayed. A “custom” tag grouping could also be selected. In one embodiment, the user can review the list and delete or add audio tracks to the list or manipulate the order.

Once the playlist is selected, the display for the performance of the audio-visual montage is selected by the “SELECT DISPLAY” button 80. The display can be a conventional display device such as a television, home theater system, projection display or home computer display. The selected display can also be the display of the hand held device 12.

The user can select the image presentation times for the images of the montage presentation with the “IMAGE DWELL TIME” button 82. For example, the images can be set for 3 seconds, 10 seconds or 20 seconds. The length of the audio track can be one limit of the number of images that can be presented. However, the number of images can also be set by the total time for the playlist so that images are not synchronous with the audio tracks and will appear during transition between tracks.

In another embodiment, the user can select the type of fade or other image transition known in the art. Transitions between images can also be randomly changed between transition types to give variety to the performance.

The performance of the playlist is initiated by pressing the “PLAY” button 84. The audio-visual montage created from the selected audio files and associated tagged images will appear on the selected display. The performance can be paused by the user by pressing the “PAUSE” button 86. The current audio track that is being performed can also be skipped to the next track by the “SKIP” button 88. In the embodiment shown in FIG. 4, the current audio file that is being performed appears in window 90 and the current image being displayed on the selected display is also shown on the interface at image window 92.

It can be seen that the performance of the audio-visual montage that is created from tagged be genre, artist or grouped by the user can be organized and defined by the user. However, in one embodiment, the performance interface 74 has a “RANDOM” button 94. The “RANDOM” button 94 randomly seeks and selects audio files and image files from the storage memory of the hand held device 12 or other designated storage location for performance on the selected display. The audio files and images can be selected at random without regard for the tags that have been applied to either the audio files or the images. No playlist is created and the montage that is performed is a random selection of audio and image or video files.

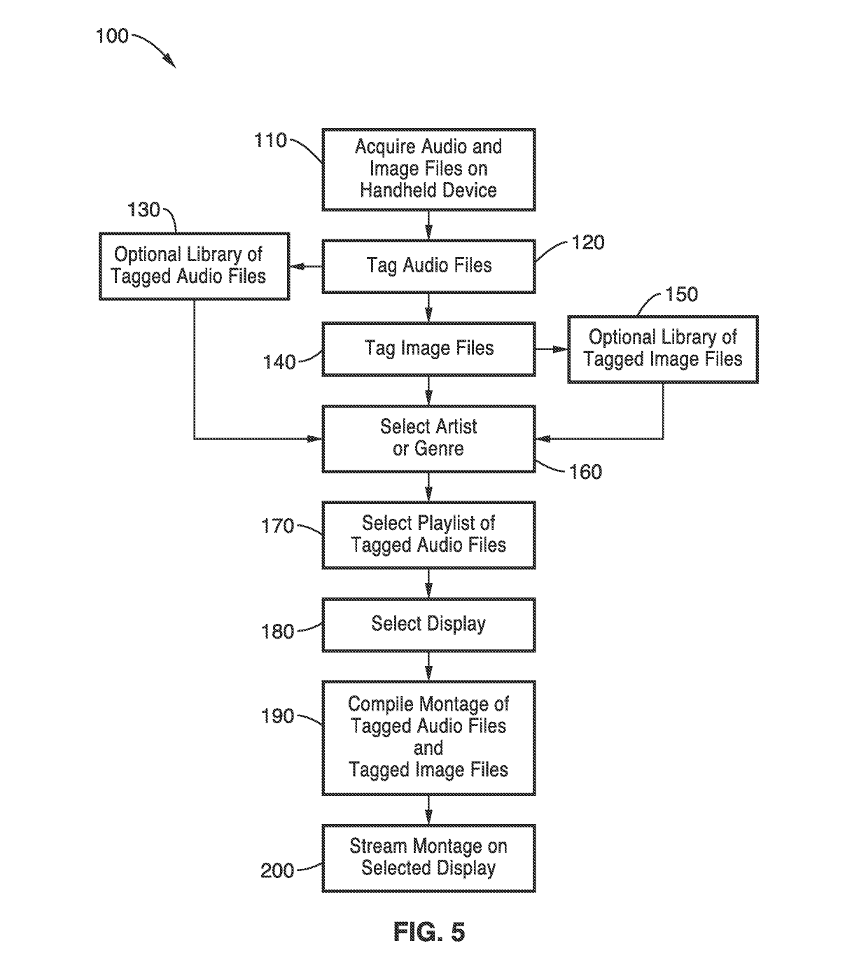

Turning now to FIG. 5, one method 100 for creating and performing an audio-video montage is schematically shown. At block 110, images/video files and audio files are acquired and stored on a hand held device from a variety of sources including the Internet, cloud resources or networked computer. The images and audio files can also be acquired and stored on an auxiliary storage media that may have been loaded by a computer or similar device.

The acquired audio files are tagged at block 120 with at least one artist tag or genre tag or user defined tag. Preferably, an acquired music track will have an artist tag and one or more music genre tags. The audio file may also have at least one image association tag selected by the user such as an “ocean scene” or “wilderness scene” with an “instrumental” audio file. The image association tag may be related to the subject matter of the audio file or could be tagged with a custom tag so that the audio file is associated with a specific image or group of images defined by the user.

The tagged audio files are optionally saved in a library of tagged audio files for easy access by the hand held device at block 130. However, with hand held devices that have limited storage capacity, the tagged audio files can be stored at their original location and are not duplicated into a separate library of tagged audio files.

At block 140, the acquired image/video files are tagged with at least one audio association indicator such as general groupings related to subject matter like “cars,” “people,” “couples,” “wildlife” and the like. The images may also be tagged with a custom tag defined by the user such as “artist name,” “family reunion” or “space images” etc. The image tags preferably correspond to the image association tags that have been applied to the audio files at block 120.

The tagged image files are saved and stored in an optional library of tagged image files at block 150. The tagged image files may be duplicated or moved to the library of tagged image files for fast access by the hand held device.

The audio and image tags are preferably incorporated into the metadata of the audio or image file. The tagged image files may also be stored at the original location of the image file without storing the file in a separate library or on an auxiliary media.

The tagging of audio and image files may also take place on a separate computing device. In one embodiment, audio files are available for purchase online that have already been tagged with artist and music genre tags. The pre-tagged audio files may also have generic image association tags including specific artist image tags. Pre-tagged images of specific artists may also be available for download in one embodiment for further promotion of the artist or the music publisher. Pre-tagged images associated with a particular audio track could also include advertising graphics or sponsorship graphics so that the graphics become part of the final montage performance.

The optional audio and image libraries created at blocks 130 and 150 can increase in size over time. In one embodiment, the libraries are indexed and organized into sub groups by genre, artist, subject matter or other custom groupings by tag. In one embodiment, the acquired audio and image files at block 110 are initially evaluated for the presence of existing tags that are then compared with a library of index of tags. The audio or image file is automatically grouped in the library according to the identified tags. If a tag is identified that does not exist in the library, the user will have the option of creating a new grouping in the library based on the tag identifier. For example, a new audio file with a metadata identifier of an artist name will be automatically grouped with all other tagged audio files for the same artist in the library. The user will also have an opportunity to apply additional tags. Pre-tagged files will automatically populate the library and may automatically create new sub-groups in this embodiment.

Creation and performance of an audio-visual montage from tagged files on a selected display begins at block 160 with the selection of audio files by artist, genre or custom grouping. A playlist of tagged audio files from the selected artist, genre or custom grouping from the audio library is created at block 170 and images with corresponding tags to the selected audio files on the playlist are identified from the library of tagged images.

A display is selected for the performance of the audio-visual montage and a connection of the hand held device to the display is established at block 180. In one embodiment of the invention the performance display is on the hand held device.

At block 190, the montage of tagged audio files and associated tagged image files is compiled. In one embodiment, the user can edit the playlist and associated image file groupings. The performance of the montage of compiled audio files and image files is streamed to the selected display device at block 200.

In an alternative embodiment without the libraries of tagged audio and image files, the user selects an artist or music genre or group. The program compiles a list of entertainment files to which the user has access i.e. (video, photo, and audio found locally or remotely) which have the “Pop-rock” data tag. The program then compiles a list of metadata tags for each file searching for performers and artists and groups them by data tag. A queue of artists and corresponding audio tracks by genre is created.

The programming automatically sorts and selects photos and videos with matching tags randomly and streams the content to the external display device as a montage of music, video, and photos that pertain to the artist. The process is repeated for the next audio file in the queue.

In one embodiment, the montage process would be a function which allows for compiling of a streaming video montage on the fly thereby providing a unique listening and viewing experience each time.

The artist or genre is selected by the user and a playlist of tagged audio files is created and a performance is initiated on a display device. The length of the music track is typically determined in tenths of a second. Optionally, a set of background graphics is randomly chosen with appropriately tagged photos and videos. Approximately every 30 seconds the background image will change so the number of background images can be determined by the length of the music track.

In another embodiment, the image file or the audio file is tagged with a “background” tag that associates an image with a particular background or a number of backgrounds. The programming selects the background based on the image background tag or the audio background tag and presents the selected background with the image as part of the audio-visual presentation in this embodiment.

A set of montage images is randomly chosen from the tagged photos and videos based on the audio track tags. These images can randomly fly-in or appear and disappear during the track play time. The number of images used in the montage may be generated at random and can be the same images or different images as the background image.

The process then randomly orders the background images and the montage images and assigns them a montage position. The process then compiles the content into a video montage. The audio track and video montage is then streamed to the external display device. In one embodiment, the performance is simultaneously presented on the hand held device 12.

Embodiments of the present invention may be described with reference to flowchart illustrations of methods and systems according to embodiments of the invention, and/or algorithms, formulae, or other computational depictions, which may also be implemented as computer program products. In this regard, each block or step of a flowchart, and combinations of blocks (and/or steps) in a flowchart, algorithm, formula, or computational depiction can be implemented by various means, such as hardware, firmware, and/or software including one or more computer program instructions embodied in computer-readable program code logic. As will be appreciated, any such computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the block(s) of the flowchart(s).

Accordingly, blocks of the flowcharts, algorithms, formulae, or computational depictions support combinations of means for performing the specified functions, combinations of steps for performing the specified functions, and computer program instructions, such as embodied in computer-readable program code logic means, for performing the specified functions. It will also be understood that each block of the flowchart illustrations, algorithms, formulae, or computational depictions and combinations thereof described herein, can be implemented by special purpose hardware-based computer systems which perform the specified functions or steps, or combinations of special purpose hardware and computer-readable program code logic means.

Furthermore, these computer program instructions, such as embodied in computer-readable program code logic, may also be stored in a computer-readable memory that can direct a computer or other programmable processing apparatus to function in a particular manner, such that the instructions stored in the computer-readable memory produce an article of manufacture including instruction means which implement the function specified in the block(s) of the flowchart(s). The computer program instructions may also be loaded onto a computer or other programmable processing apparatus to cause a series of operational steps to be performed on the computer or other programmable processing apparatus to produce a computer-implemented process such that the instructions which execute on the computer or other programmable processing apparatus provide steps for implementing the functions specified in the block(s) of the flowchart(s), algorithm(s), formula(e), or computational depiction(s).

From the discussion above it will be appreciated that the invention can be embodied in various ways, including the following:
1. An apparatus for producing an audio-visual montage, comprising an audiovisual display; a computing device operably coupled to the audiovisual display; and programming executable on the computing device for: acquiring a plurality of audio files and a plurality of image or video files; tagging each audio file with at least one audio tag; tagging each image and video file with at least one image tag; creating an audio-visual montage from the tagged audio files and tagged image files associated according to their tags; and performing the created montage on the audiovisual display.
2. The apparatus of embodiment 1, further comprising a library of tagged audio files accessible to the computing device.
3. The apparatus of embodiment 2, further comprising a library of tagged image and video files accessible to the computing device.
4. The apparatus of embodiment 1, wherein the audio files are tagged with a music genre tag and at least one image association tag.
5. The apparatus of embodiment 4, wherein the image association tag is selected from the group of tags consisting essentially of a landscape tag, an ocean scene tag, a forest scene tag, a wildlife tag, an urban scene tag, a motorcycle tag, a people tag, a musician tag, a rock concert tag and a user defined tag.
6. The apparatus of embodiment 4, further comprising programming executable on the computing device for tagging the audio files with at least one rhythm style tag and at least one mood tag.
7. The apparatus of embodiment 1, further comprising programming executable on the computing device for selecting at least one background for the display of images as part of the audio-visual montage.
8. The apparatus of embodiment 1, wherein said image tag is selected from the group of tags consisting of an artist tag, a landscape tag, an ocean scene tag, a forest scene tag, a wildlife tag, an urban scene tag, a motorcycle tag, a people tag, a musician tag, a rock concert tag, a mood tag, a rhythm tag and a user defined tag.
9. The apparatus of embodiment 1, further comprising programming executable on the computing device for: selecting a plurality of tagged audio files to form a playlist; matching tagged image and video files with each selected audio file according to one or more audio tags and one or more image tags; and selecting an image dwell time; wherein the number of images displayed with a tagged audio file is determined by the selected image dwell time and a play length of the audio file.
10. An apparatus for producing and performing an audio-visual montage, comprising: an audiovisual display; a computing device operably coupled to the audiovisual display; and programming executable on the computing device for: creating a library of a plurality of audio files tagged with at least one audio tag and at least one image association tag accessible to the computing device; creating a library of a plurality of image files tagged with at least one audio tag accessible to the computing device; selecting a playlist of tagged audio files from the library of audio files; associating tagged images with each selected audio file corresponding with the audio tags of the audio file to create an audio-visual montage; and transmitting the audio-visual montage from the computing device to a remote audio-visual display.
11. The apparatus of embodiment 10, wherein the tagged audio files of the playlist are selected by at least one audio tag.
12. The apparatus of embodiment 11, wherein audio tags used to form the playlist are tags selected from the group of tags consisting essentially of an artist tag, a music genre tag, a mood tag, a rhythm tag and a user defined tag.
13. The apparatus of embodiment 10, wherein the audio files are tagged with at least one image association tag.
14. The apparatus of embodiment 13, wherein the image association tag is selected from the group of tags consisting essentially of a landscape tag, an ocean scene tag, a forest scene tag, a wildlife tag, an urban scene tag, a motorcycle tag, a people tag, a musician tag, a rock concert tag and a user defined tag.
15. The apparatus of embodiment 10, wherein the playlist is randomly selected from audio files from the library of audio files and the images associated with the selected audio files are randomly selected from the library of images or videos.
16. The apparatus of embodiment 10, further comprising programming executable on the computing device for selecting at least one background for the display of images as part of the audio-visual montage.
17. The apparatus of embodiment 10, wherein the library of tagged audio files and said library of images or videos are wirelessly accessible to the computing device from a remote location.
18. An apparatus for producing and performing an audio-visual montage, comprising: an audiovisual display; a computing device; a wireless receiver operably coupled to the audiovisual display and the computing device; and programming executable on the computing device for acquiring a plurality of audio files and image/video files; tagging the acquired audio files with an artist name audio tag, a music genre tag and an image association tag; tagging the acquired image and video files with an image tag; creating a library of a plurality of tagged audio files and storing the audio library in a hand held device; creating a library of a plurality of tagged image/video files and storing the image library in the hand held device; selecting a playlist of tagged audio files from the library of audio files based on the audio file tags; selecting images corresponding with the audio tags of each audio file and at least one display background to create an audio-visual montage; and performing the audio-visual montage on a remote audio-visual display.
19. The apparatus of embodiment 18, further comprising programming executable on the computing device for tagging each image file with at least one background tag; wherein the background for the display of the image as part of the audio-visual montage is determined by the background tag.
20. The apparatus of embodiment 18, wherein the audio tags and associated image tags are defined by the user.
21. A method for producing an audio-visual montage, comprising: executing a computer program on a computer device to carry out steps comprising: acquiring a plurality of audio files and a plurality of image and video files; tagging each audio file with at least one audio tag; tagging each image and video file with at least one image tag; creating an audio-visual montage from the tagged audio files and tagged image files associated according to their tags; and performing the created montage on a display.
22. The method of embodiment 21, further comprising: creating a library of tagged audio files accessible to a hand held computing device.
23. The method of embodiment 22, further comprising: creating a library of tagged image and video files accessible to a hand held computing device.
24. The method of embodiment 21, wherein said audio files are tagged with a music genre tag and at least one image association tag.
25. The method of embodiment 24, wherein said image association tag is selected from the group of tags consisting essentially of a landscape tag, an ocean scene tag, a forest scene tag, a wildlife tag, an urban scene tag, a motorcycle tag, a people tag a musician tag, a rock concert tag and a user defined tag.
26. The method of embodiment 24, further comprising tagging said audio files with at least one rhythm style tag and at least one mood tag.
27. The method of embodiment 21, further comprising: selecting at least one background for the display of images as part of the audio-visual montage.
28. The method of embodiment 21, wherein said image tag is selected from the group of tags consisting of an artist tag, a landscape tag, an ocean scene tag, a forest scene tag, a wildlife tag, an urban scene tag, a motorcycle tag, a people tag, a musician tag, a rock concert tag, a mood tag, a rhythm tag and a user defined tag.
29. The method of embodiment 21, wherein said audio-visual montage creation comprises: selecting a plurality of tagged audio files to form a playlist; matching tagged image and video files with each selected audio file according to one or more audio tags and one or more image tags; and selecting an image dwell time; wherein the number of images displayed with a tagged audio file is determined by the selected image dwell time and a play length of the audio file.
30. A method for producing and performing an audio-visual montage, comprising: executing, on a computing device, programming for carrying out steps comprising: creating a library of a plurality of audio files tagged with at least one audio tag and at least one image association tag accessible to the computing device; creating a library of a plurality of image files tagged with at least one audio tag accessible to the computing device; selecting a playlist of tagged audio files from the library of audio files; associating tagged images with each selected audio file corresponding with the audio tags of the audio file to create an audio-visual montage; and transmitting the audio-visual montage from the hand held device to a remote audio-visual display.
31. The method of embodiment 30, wherein the tagged audio files of said playlist are selected by at least one audio tag.
32. The method of embodiment 31, wherein audio tags used to form the playlist are tags selected from the group of tags consisting essentially of an artist tag, a music genre tag, a mood tag, a rhythm tag and a user defined tag.
33. The method of embodiment 30, wherein said audio files are tagged with at least one image association tag.
34. The method of embodiment 33, wherein said image association tag is selected from the group of tags consisting essentially of a landscape tag, an ocean scene tag, a forest scene tag, a wildlife tag, an urban scene tag, a motorcycle tag, a people tag a musician tag, a rock concert tag and a user defined tag.
35. The method of embodiment 30, wherein said playlist is randomly selected from audio files from the library of audio files and said images associated with the selected audio files are randomly selected from the library of images or videos.
36. The method of embodiment 30, further comprising: selecting at least one background for the display of images as part of the audio-visual montage.
37. The method of embodiment 30, wherein said library of tagged audio files and said library of images or videos are wirelessly accessible to the computing device from a remote location.
38. A method for producing and performing an audio-visual montage, comprising: acquiring a plurality of audio files and image/video files; executing a computer program on a computer device to carry out steps comprising: tagging the acquired audio files with an artist name audio tag, a music genre tag and an image association tag; tagging the acquired image and video files with an image tag; creating a library of a plurality of tagged audio files and storing the audio library in a computing device; creating a library of a plurality of tagged image/video files and storing the image library in the computing device; selecting a playlist of tagged audio files from the library of audio files based on the audio file tags; selecting image/video files corresponding with the audio tags of each audio file and at least one display background to create an audio-visual montage; and performing the audio-visual montage on a remote audio-visual display.
39. The method of embodiment 38, further comprising: tagging each image file with at least one background tag; wherein the background for the display of the image as part of the audio-visual montage is determined by the background tag.
40. The method of embodiment 38, wherein said audio tags and associated image tags are defined by the user.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. An apparatus for producing an audio-visual montage, comprising:
an audiovisual display;
a computing device operably coupled to the audiovisual display; and
programming executable on the computing device for:
acquiring a plurality of audio files and a plurality of image or video files;
tagging each audio file with at least one audio tag;
tagging each image and video file with at least one image tag;
creating an audio-visual montage from the tagged audio files and tagged image files associated according to their tags; and
performing the created montage on the audiovisual display.

2. An apparatus as recited in claim 1, further comprising:
a library of tagged audio files accessible to the computing device.

3. An apparatus as recited in claim 2, further comprising:
a library of tagged image and video files accessible to the computing device.

4. An apparatus as recited in claim 1, wherein said audio files are tagged with a music genre tag and at least one image association tag.

5. An apparatus as recited in claim 4, wherein said image association tag is selected from the group of tags consisting essentially of a landscape tag, an ocean scene tag, a forest scene tag, a wildlife tag, an urban scene tag, a motorcycle tag, a people tag, a musician tag, a rock concert tag and a user defined tag.

6. An apparatus as recited in claim 4, further comprising programming executable on the computing device for tagging said audio files with at least one rhythm style tag and at least one mood tag.

7. An apparatus as recited in claim 1, further comprising programming executable on the computing device for selecting at least one background for the display of images as part of the audio-visual montage.

8. An apparatus as recited in claim 1, wherein said image tag is selected from the group of tags consisting of an artist tag, a landscape tag, an ocean scene tag, a forest scene tag, a wildlife tag, an urban scene tag, a motorcycle tag, a people tag, a musician tag, a rock concert tag, a mood tag, a rhythm tag and a user defined tag.

9. An apparatus as recited in claim 1, further comprising programming executable on the computing device for:
selecting a plurality of tagged audio files to form a playlist;
matching tagged image and video files with each selected audio file according to one or more audio tags and one or more image tags; and
selecting an image dwell time;
wherein the number of images displayed with a tagged audio file is determined by the selected image dwell time and a play length of the audio file.

10. An apparatus for producing and performing an audio-visual montage, comprising:
an audiovisual display;
a computing device operably coupled to the audiovisual display; and
programming executable on the computing device for:
creating a library of a plurality of audio files tagged with at least one audio tag and at least one image association tag accessible to the computing device;
creating a library of a plurality of image files tagged with at least one audio tag accessible to the computing device;
selecting a playlist of tagged audio files from the library of audio files;
associating tagged images with each selected audio file corresponding with the audio tags of the audio file to create an audio-visual montage; and
transmitting the audio-visual montage from the computing device to a remote audio-visual display.

11. An apparatus as recited in claim 10, wherein the tagged audio files of said playlist are selected by at least one audio tag.

12. An apparatus as recited in claim 11, wherein audio tags used to form the playlist are tags selected from the group of tags consisting essentially of an artist tag, a music genre tag, a mood tag, a rhythm tag and a user defined tag.

13. An apparatus as recited in claim 10, wherein said audio files are tagged with at least one image association tag.

14. An apparatus as recited in claim 13, wherein said image association tag is selected from the group of tags consisting essentially of a landscape tag, an ocean scene tag, a forest scene tag, a wildlife tag, an urban scene tag, a motorcycle tag, a people tag, a musician tag, a rock concert tag and a user defined tag.

15. An apparatus as recited in claim 10, wherein said playlist is randomly selected from audio files from the library of audio files and said images associated with the selected audio files are randomly selected from the library of images or videos.

16. An apparatus as recited in claim 10, further comprising programming executable on the computing device for selecting at least one background for the display of images as part of the audio-visual montage.

17. An apparatus as recited in claim 10, wherein said library of tagged audio files and said library of images or videos are wirelessly accessible to the computing device from a remote location.

18. A method for producing and performing an audio-visual montage, comprising:
executing a computer program on a computer device to carry out steps comprising:
acquiring a plurality of audio files and image/video files;
tagging the acquired audio files with an artist name audio tag, a music genre tag and an image association tag;
tagging the acquired image and video files with an image tag;
creating a library of a plurality of tagged audio files and storing the audio library in a computer device;
creating a library of a plurality of tagged image/video files and storing the image library in the computer device;
selecting a playlist of tagged audio files from the library of audio files based on the audio file tags;
selecting image/video files corresponding with the audio tags of each audio file and at least one display background to create an audio-visual montage; and
performing the audio-visual montage on a remote audio-visual display.

19. A method as recited in claim 18, further comprising:
tagging each image/video file with at least one background tag;
wherein the background for the display of the image as part of the audio-visual montage is determined by the background tag.

20. A method as recited in claim 38, wherein said audio tags and associated image tags are defined by the user.
